(19) United States
(12) Patent Application Publication
(10) Pub. No.: US 2009/0243848 A1
(43) Pub. Date: Oct. 1, 2009

(54) REFERENCE POINT LOCATOR

(75) Inventor: Mark TURNER, Arlington, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(73) Assignee: LABOR SAVINGS SYSTEMS, LTD., Arlington, TX (US)

(21) Appl. No.: 12/414,964

(22) Filed: Mar. 31, 2009

Related U.S. Application Data
(60) Provisional application No. 61/041,414, filed on Apr. 1, 2008.

(51) Int. Cl. G08B 21/00; H01F 7/02

(52) U.S. Cl. 340/540; 29/607

(57) ABSTRACT

A reference point locator comprises a reference member and a receiver. The reference member includes an attachment element and a magnet. The attachment element is configured to releasably secure the reference member to one side of a structure. The receiver includes a sensor and an indicator. The indicator is configured to emit a signal in response to the sensor detecting from another side of the structure a magnetic field generated by the magnet.

### CROSS-REFERENCE TO RELATED PATENT APPLICATIONS

This patent application claims the benefit of U.S. Provisional Patent Application No. 61/041,414, filed Apr. 1, 2008, the teachings and disclosure of which are hereby incorporated in their entireties by reference thereto.

### BACKGROUND

In the past, one of the methods used by an installer or other technician (e.g., an electrician) to locate a reference point on a first side of a structure (e.g., a wall, floor, ceiling, etc.) from a second side of the structure involved considerable guesswork. To begin, the installer would guess where the reference point might be on the first side of the structure. The installer would then drill a small test hole through the structure from the second side at the presumed location. With the test hole completed, the installer would move back to the first side of the structure and observe where the test hole came through the wall.

If the small hole came through the wall on the first side of the structure at or sufficiently proximate the reference point, the reference point was found and no further small holes were required. However, if the small hole came through the wall on the first side of the structure undesirably or substantially far away from the reference point, the installer would move back to the second side of the structure, make another guess where the reference point might be on the first side (probably using the first small hole as a guide), and drill another test hole from the second side at the new location. Eventually, by repeating the above process a sufficient number of times, one of the subsequently drilled test holes would be located on the first side of the structure at or sufficiently proximate the reference point on the first side. With the reference point now found, the installer is free to continue on with his work (e.g., fishing electrical wire to a new outlet being installed).

The above method involves considerable guesswork and is prone to error, even for an experienced installer. The need to repair one or more test holes requires time and adds unneeded expense to a project.

### BRIEF DESCRIPTION OF THE DRAWINGS

For a more complete understanding of the present application, reference is now made to the following descriptions taken in conjunction with the accompanying drawings, in which:

FIG. 1 is an embodiment of a reference point locator;

FIG. 2 is an exploded view of a reference member of the reference point locator of FIG. 1;

FIG. 3 is a bottom view of a handle of the reference member of FIG. 2;

FIG. 4 is a cross section view of the handle of FIG. 3;

FIG. 5 is another embodiment of a reference member of the reference point locator of FIG. 1;

FIG. 6 is a front view of an embodiment of a kit including the reference point locator of FIG. 1;

FIG. 7 is a simplified schematic of the reference member of FIG. 1 disposed in a ceiling vertically above and aligned with a desired site for an electrical outlet;

FIG. 8 is a simplified schematic illustrating use of the receiver of FIG. 1 with the reference member of FIG. 5;

FIG. 9 is an embodiment of a receiver having an accuracy-enhancing device in a retracted position;

FIG. 10 illustrates the receiver of FIG. 9 having the accuracy-enhancing device in an extended position;

FIG. 11 is a simplified schematic illustrating use of the receiver of FIG. 9 with the reference member of FIG. 5 and with the accuracy-enhancing device in the retracted position;

FIG. 12 is a simplified schematic illustrating use of the receiver of FIG. 9 with the reference member of FIG. 5 and with the accuracy-enhancing device in the extended position; and

FIG. 13 is a simplified schematic illustrating use of the receiver of FIG. 9 with the reference member of FIG. 5.

### DETAILED DESCRIPTION OF THE DRAWINGS

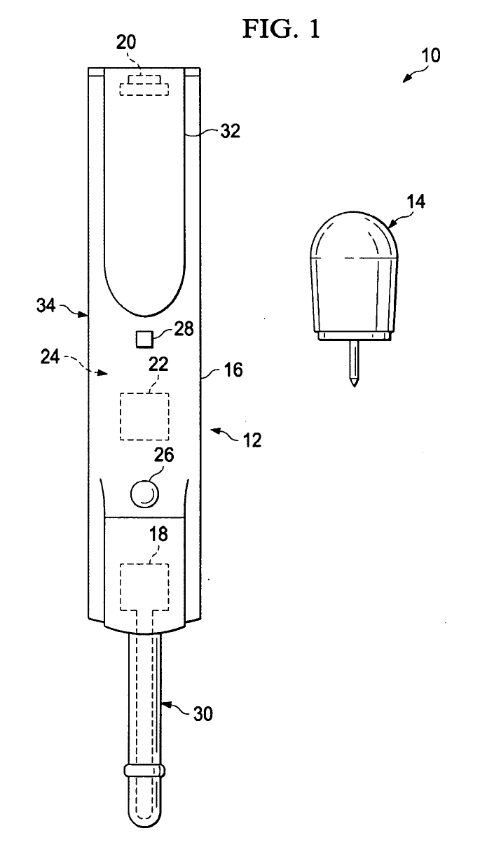

Referring now to FIG. 1, a reference point locator 10 is illustrated. As will be more fully explained below, reference point locator 10 permits an installer (e.g., an electrician) to quickly, easily and conveniently find a reference point through a structure such as a wall, ceiling or floor. Indeed, reference point locator 10 mitigates or eliminates guesswork and the need to make repairs to the structure therefore saving both time and money. As shown in FIG. 1, reference point locator 10 comprises a receiver 12 and a reference member 14.

In the embodiment illustrated in FIG. 1, receiver 12 comprises a wand housing 16 sheltering a magnetic field sensor 18, a power source 20, and electronic circuitry 22 in an internal cavity 24 of wand housing 16. Wand housing 16 also supports an indicator 26 and a switch 28. In some embodiments, wand housing 16 is generally sized and dimensioned to fit comfortably within the hand of the installer such that receiver 12 may be hand-held by the installer. In addition, wand housing 16 may be made from a variety of suitable materials such as, for example, plastic and metal. Therefore, in some embodiments receiver 12 is a generally light-weight and easy-to-use tool.

In the illustrated embodiment of FIG. 1, wand housing 16 includes a probe portion 30 and a resilient clip 32 formed at opposing ends of a main body 34. Probe portion 30 and main body 34 carry and protect magnetic field sensor 18 and/or electronic circuitry 22 within internal cavity 24 of wand housing 16. Resilient clip 32 is externally arranged on wand housing 16 to clamp receiver 12 onto, for example, a shirt pocket, a pair of pants, a belt, and the like. Using resilient clip 32, the installer is able to quickly and easily deploy receiver 12 during an installation and to temporarily store receiver 12 when not in use. However, in should be understood that receiver 12 may be formed with resilient clip 32 omitted.

When switch 28 permits, magnetic field sensor 18, power source 20, indicator 26, switch 28 and electronic circuitry 22 are in electrical communication with each other. Magnetic field sensor 18 is configured to detect the presence and/or the intensity of a magnetic field. In one embodiment, magnetic field sensor 18 is a reed switch. Power source 20 in wand housing 16 may be a replaceable battery, a rechargeable battery, or some other suitable type of battery. In the illustrated embodiment, power source 20 is a plurality of small disc-shaped batteries.

Indicator 26 is a device capable of generating a signal that will be perceived by the installer. Because receiver 12 is capable of operating in a variety of different environments (e.g., dark attics, noisy construction sites, etc.) indicator 26 is able to produce one or more types of perceivable signals (e.g., audible, visual, vibrotactile, etc.) either alone or in combination. In the illustrated embodiment of FIG. 1, indicator 26 is configured to generate both an audible and a visual signal (e.g., a beep and a light via a light-emitting diode (LED)). Therefore, indicator 26 is able to emit both an audible and a visual signal when a magnetic field is detected. The indicator 26 may emit the audible and visual signals separately or simultaneously. In the illustrated embodiment of FIG. 1, switch 28 is a toggle switch used to transition the receiver between “on” and “off” states. However, switch 28 may also control other functions of receiver 12 such as, for example, a characteristic of indicator 26 (e.g., volume, type of signal, etc.), sensitivity of magnetic field sensor 18, and/or different modes of receiver 12 operation. In other embodiments, a plurality of switches 28 may be employed to control various functions of receiver 12. In addition, switch(es) 28 may comprise knobs, wheels, buttons, and other devices.

Electronic circuitry 22 generally manages operation of receiver 12. In that regard, electronic circuitry 22 receives and distributes power from power source 20, receives information from magnetic field sensor 18, and relays commands to indicator 26. Electronic circuitry 22 generally responds to manipulation of switch 28. If, for example, switch 28 is manipulated into the “off” position, electronic circuitry 22 temporarily disables receiver 12. If, however, the switch is placed into the “on” position, electronic circuitry 22 permits operation of receiver 12.

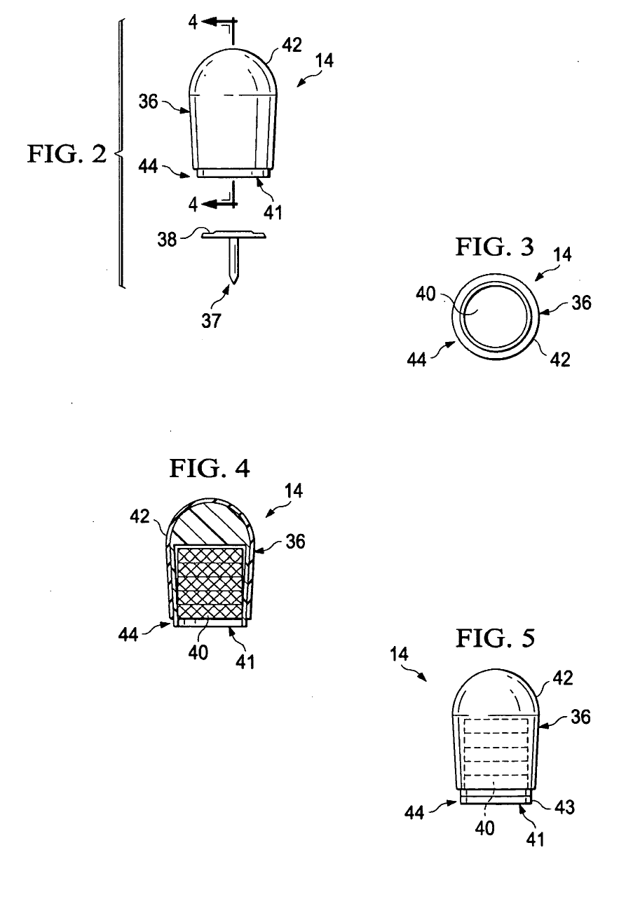

Referring now to FIG. 2, reference member 14 generally includes a handle 36 and an attachment element 37. Handle 36 comprises one or more magnets 40 (see also FIG. 4) surrounded at least partially by a covering 42. Covering 42 may be constructed from a variety of suitable materials such as, for example, plastic or rubber. As shown in FIG. 3, covering 42 generally leaves a portion of the magnet 40 exposed proximate a bottom end 44 of handle 36. Even so, covering 42 may also completely surround or enclose the magnet 40 in other embodiments. In the illustrated embodiment of FIG. 4, a portion of covering 42 projects beyond magnet 40 to form a cavity 41 proximate bottom end 44 of handle 36.

Attachment element 37 is employed to secure handle 36 to a portion or surface of a structure. In the embodiment illustrated in FIG. 2, attachment element 37 comprises a thumb tack 38. However, in other embodiments attachment element 37 may be a threaded member (e.g., a screw), a cork screw wire, an anchoring device, etc. In the illustrated embodiment of FIG. 2, cavity 41 is particularly sized and dimensioned to receive a top push portion of thumb tack 38.

Thumb tack 38, which is formed from metal or other suitable material, is releaseably secured to handle 36 proximate bottom end 44 using the magnetic field generated by magnet 40 in handle 36. As shown in FIG. 2, when the force of the magnetic field is overcome, thumb tack 38 is disengageable from handle 36. To reattach thumb tack 38 to handle 36, thumb tack 38 need only be moved close enough to handle 36 for the magnetic field to grab and hold thumb tack 38. However, it should be understood that other types of attachment elements 37 may be used, and that other means to attach attachment element 37 to handle 36 may be used. It should be understood that handle 36 may have attachment element 37 incorporated internally therein and/or formed as a part thereof (e.g., as a unitary structure).

Further, even though depicted as a handle 36 and a thumb tack 38 in FIGS. 2-4, reference member 14 may have a variety of other suitable constructions and configurations. For example, as depicted in FIG. 5, thumb tack 38 of FIG. 2 may be replaced by an adhering member 43. Adhering member 43 is either permanently or removeably disposed within cavity 41 of handle 36. Adhering member 43 may be a sticky or tacky material (e.g., putty, gel, adhesive paper, etc.), a suction producing device, or other type of device/material to secure handle 36 to a portion or surface of a structure. Depending on the particular adhering member 43 selected, adhering member 43 may prevent damage to the wall, ceiling, floor, or other structure.

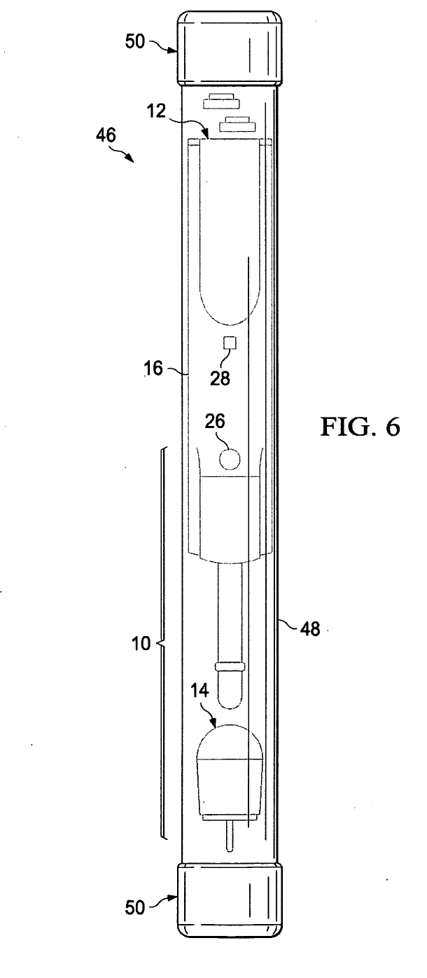

As shown in FIG. 6, receiver 12 and reference member 14, along with other accessories such as, for example, batteries, may be packaged together in a kit 46. In the illustrated embodiment of FIG. 6, kit 46 is formed from a hollow tube 48 covered on each end by a cap 50. Tube 48 is generally made form a transparent material (e.g., clear plastic) to permit the purchaser to view the items therein. Caps 50 may be formed a variety of suitable materials such as, for example, plastic or rubber. However, it should be understood that other types of containers or packaging may be used to house receiver 12, reference member 14, and other accessories.

To produce kit 46 of FIG. 6, one of caps 50 is fitted over one of the ends of tube 48. Next, receiver 12, reference member 14, and other accessories are inserted in tube 48. With receiver 12, reference member 14, and batteries now disposed within tube 48, another of caps 50 is fitted over the still open opposing end of tube 48. If desired, tape, epoxy, or other material may be used to secure caps 50 to tube 48. When assembled in this fashion, kit 46 may be conveniently offered for retail sale to consumers, sold to retailers at wholesale, and/or shipped to commercial outlets. In some embodiments, kit 46 may comprise a case, a container, and/or packaging suitable for holding receiver 12, reference member 14, and/or other accessories.

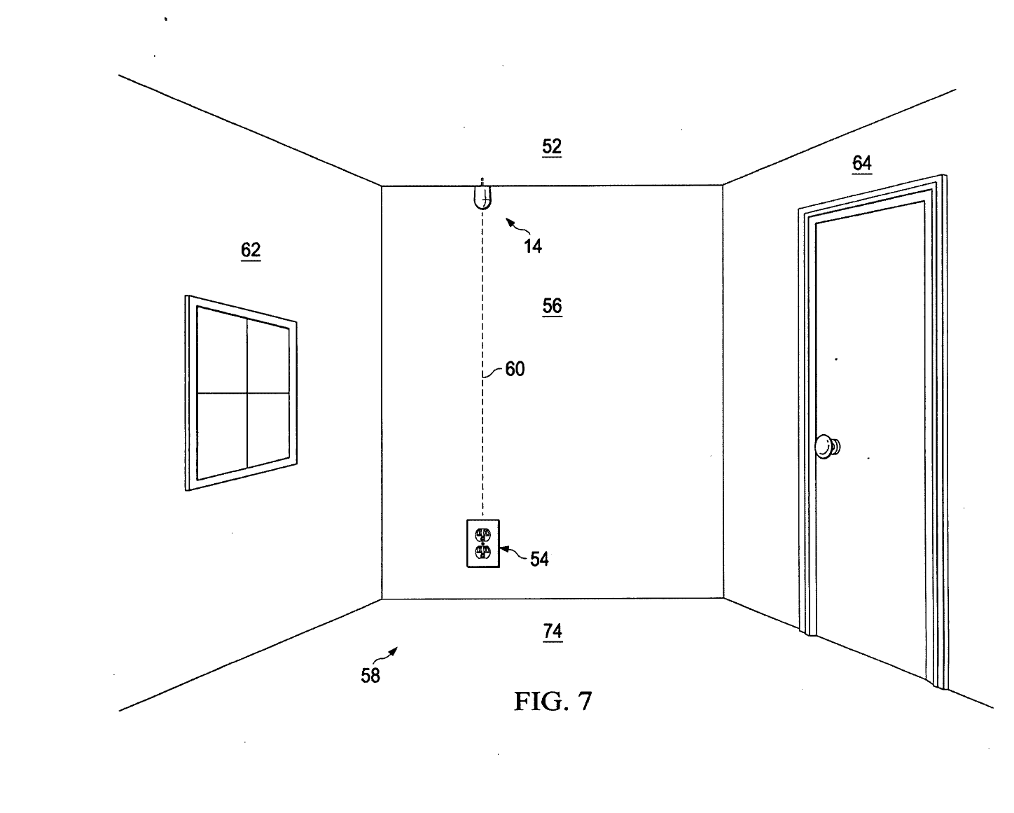

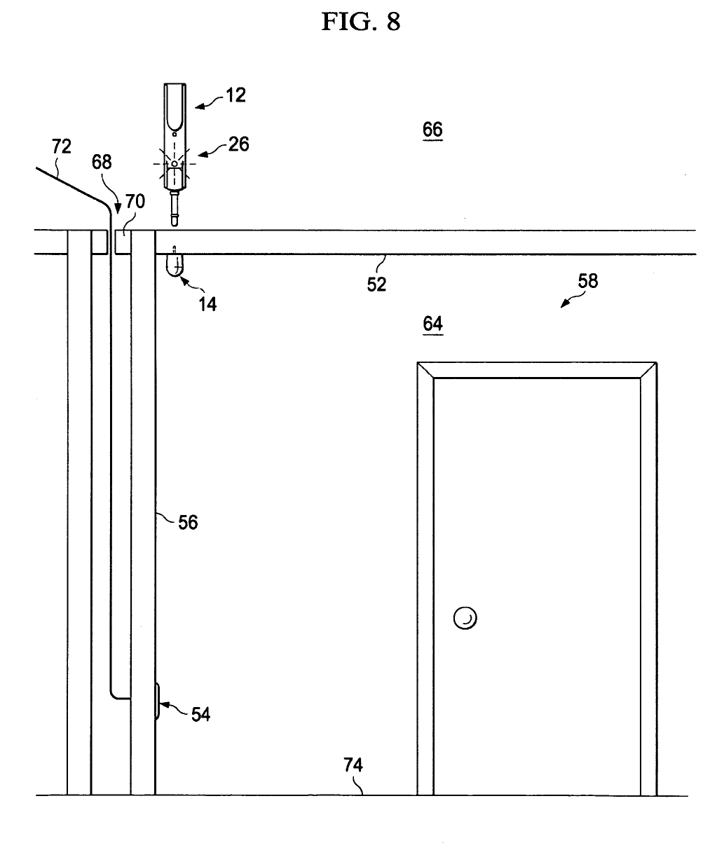

In operation, as shown in FIG. 7 reference member 14 of reference point locator 10 is inserted into ceiling 52 directly above a reference point 54 depicted as a proposed electrical outlet in back wall 56 of a room 58, using handle 36. Alternatively, reference member 14 of reference point locator 10 may be inserted into wall 56 directly above a reference point 54. As shown, reference member 14 is vertically aligned, or nearly vertically aligned, with reference point 54 along reference line 60 and horizontally spaced apart from each of the side walls 62, 64 the same distance as reference point 54. Thumb tack 38 holds reference member 14 in this suspended position while the installer moves to attic 66 illustrated in FIG. 8.

Once within attic 66, the installer turns “on” receiver 12 using switch 28 (if receiver 12 is not already been turned “on”) and sweeps receiver 12 along back wall 56 on the opposite side of ceiling 52. When receiver 12 comes into proximity with reference member 14, magnetic field sensor 18 detects the presence of a magnetic field and indicator 26 is activated. The activated indicator 26 advises the installer of the location of reference member 14, which is on the other side of ceiling 52 and completely hidden from view.

With the location of reference member 14 determined, the installer may drill a hole 68 through header board 70 between studs (not shown) at or around the point marked by reference member 14 and located by receiver 12. Thereafter, the installer feeds electrical wire 72 through hole 68 in header board 70 and down to reference point 54. With the electrical wire 72 now running behind back wall 56 and down to reference point 54, the installer may appropriately connect the electrical outlet to a source of electrical power and/or withdraw wire 72 through wall 56 at an opening at reference point 54.

In the above example of operation, only one small hole (which does not pass through the entire ceiling 52) is made by thumb tack 38 in locating the reference point marked by reference member 14. If thumb tack 38 is replaced by a sticky material, no holes need be made in the ceiling at all. Also, while the operation has been described and depicted in conjunction with a ceiling 52, reference point locator 10 may also be used to locate reference points on reverse, opposing, or hidden sides of walls (e.g., walls 56, 62, 64), floors 74, etc.

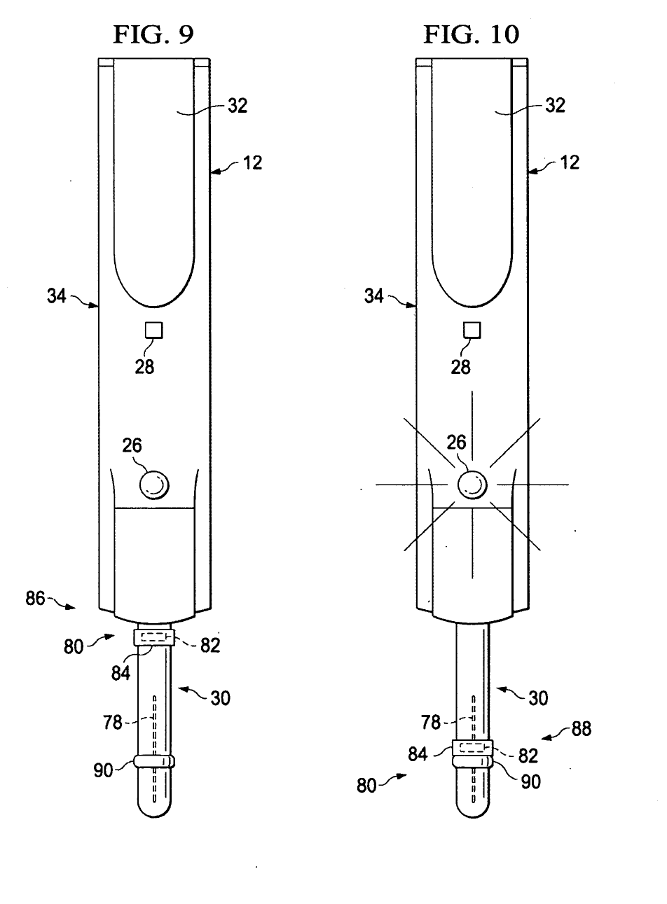

In FIG. 9, another embodiment of receiver 12 of reference point locator 10 is illustrated. In FIG. 9, the magnetic field sensor 18 disposed within receiver 12 is a reed switch 78 (e.g., a normally-open reed switch). In addition, receiver 12 of FIG. 9 is equipped with an accuracy-enhancing device 80 moveably disposed on probe portion 30 of receiver 12. In some embodiments, the accuracy-enhancing device 80 is an annular magnet 82 slideably disposed on the probe portion 30 of receiver 12. The annular magnet 82 may be seated inside a cover 84 or other protective housing formed from plastic or another suitable material.

When in a retracted position 86 as depicted in FIG. 9, annular magnet 82 is seated against or proximate to main body 34 of receiver 12. In retracted position 86, annular magnet 82 does not have sufficient influence upon reed switch 78 to change the state of the contacts. In other words, annular magnet 82 does not generate a strong enough magnetic field from retracted position 86 to close reed switch 78 and permit current to flow. As shown in FIG. 9, when annular magnet 82 is in retracted position 86, magnet 82 does not cause activation of indicator 26.

When in an extended position 88 as depicted in FIG. 10, annular magnet 82 is seated against or proximate to a stop 90 on probe portion 30 of receiver 12. In extended position 88, annular magnet 82 has sufficient influence upon reed switch 78 to change the state of the contacts. In other words, annular magnet 82 generates a strong enough magnetic field in extended position 88 to close reed switch 78 and permit current to flow. As shown in FIG. 10, when annular magnet 82 is in extended position 88, indicator 26 is activated.

Referring to FIGS. 9 and 10, annular magnet 82 may be held in either retracted position 86 or extended position 88 by a friction fit between annular magnet 82 and probe portion 30 of receiver. Despite the friction fit, annular magnet 82 may be transitioned into and between retracted position 86 and extended position 88 by a user of receiver 12 (e.g., an installer).

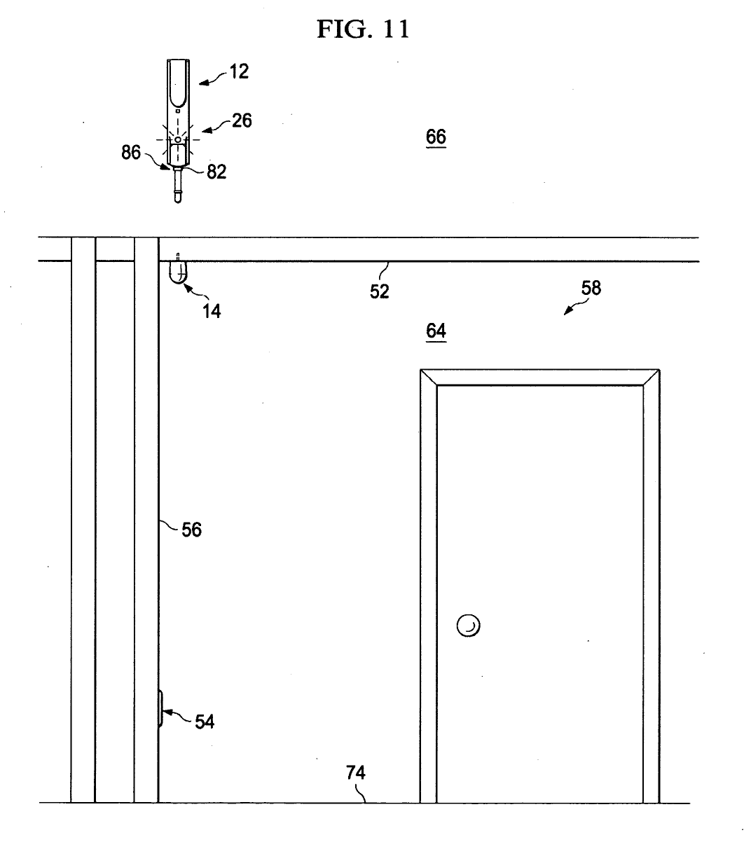

In operation as shown in FIG. 11, after reference member 14 has been located above a reference point 54 as previously described in conjunction with FIG. 7, the installer sweeps receiver 12 along back wall 56 on the opposite side of ceiling 52 with annular magnet 82 in retracted position 86. When receiver 12 comes into proximity with reference member 14, reed switch 78 (FIGS. 9-10) closes and indicator 26 is activated. The activated indicator 26 advises the installer of the general location of reference member 14, which is on the other side of ceiling 52 and completely hidden from view.

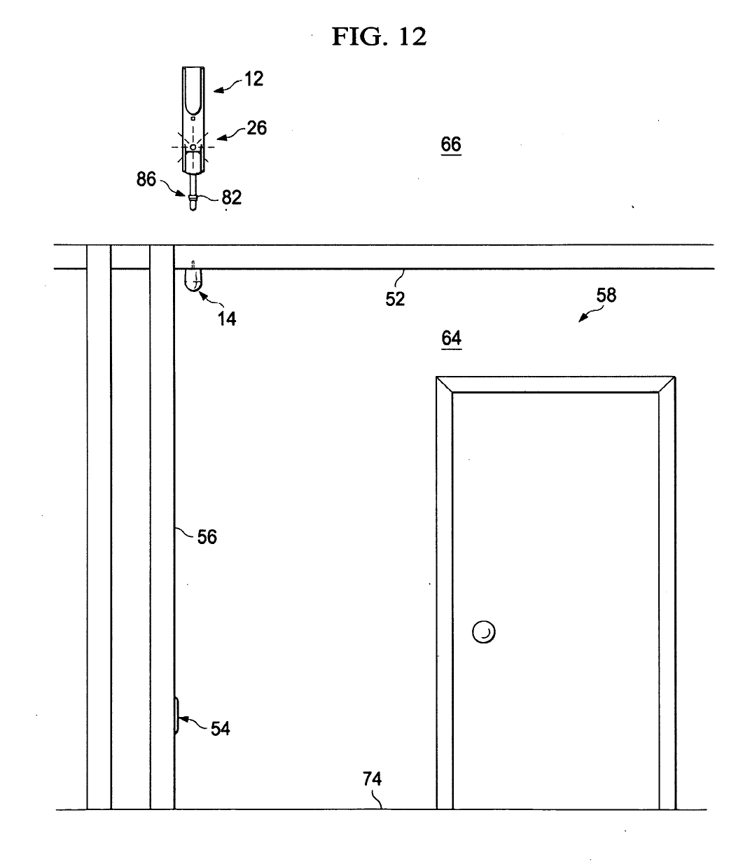

With the general location of reference member 14 determined, the installer moves annular magnet 82 from retracted position 86 as shown in FIG. 11 to extended position 88 as shown in FIG. 12. When annular magnet 82 is disposed in extended position 88, annular magnet 82 acts upon reed switch 78 in probe portion 30 of receiver 12 such that reed switch 78 remains closed and indicator 26 remains active even if receiver 12 is moved away from reference member 14. In other words, the influence of annular magnet 82, and not magnet 40 (FIG. 4) of reference member 14, holds reed switch 78 closed and keeps indicator 26 activated.

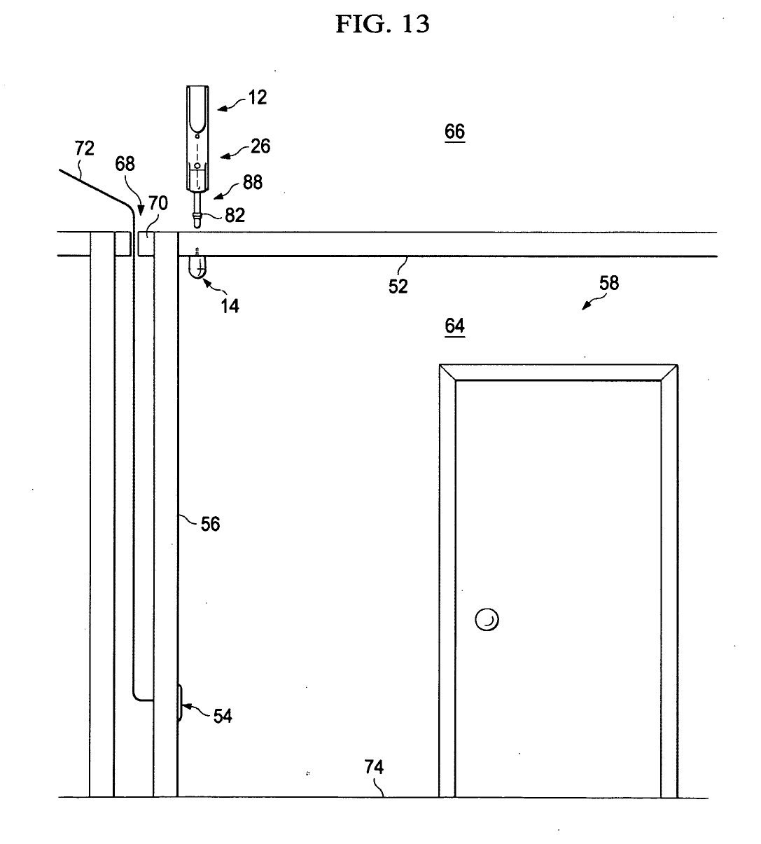

Now that the general location of reference member 14 is known, the installer determines a more precise location of reference member 14. To do so, the installer carefully sweeps or moves receiver 12 around in the area of the general location and, perhaps, closer to ceiling 52 than before as shown in FIG. 13. When receiver 12 comes in sufficiently close proximity to reference member 14, the magnetic field produced by magnet 40 of reference member 14 counteracts the magnetic field generated by annular magnet 82 disposed on probe portion 30 of receiver 12 such that reed switch 78 opens and indicator 26 is deactivated. The deactivated indicator 26 advises the installer of the precise location of reference member 14, which is still on the other side of ceiling 52 and completely hidden from view.

With the precise location of reference member 14 determined, installer may drill a hole 68 through header board 70 between studs (not shown) at or around the point marked by reference member 14 and located by receiver 12. Thereafter, the installer feeds electrical wire 72 through hole 68 in header board 70 and down to reference point 54. With the electrical wire 72 now running behind back wall 56 and down to reference point 54, the installer may appropriately connect the electrical outlet to a source of electrical power and/or withdraw wire 72 through wall 56 at reference point 54.

What is claimed is:

1. A reference point locator, comprising:
a reference member supporting a magnet and an attachment element, the attachment element for releasably coupling the reference member to a first side of a structure; and
a receiver comprising a sensor and an indicator, the indicator configured to emit a signal in response to the sensor detecting from a second side of the structure a magnetic field generated by the magnet.

2. The reference point locator of claim 1, wherein the reference member is releasably couplable to the first side of the structure via a thumb tack.

3. The reference point locator of claim 1, wherein the reference member is independently couplable to the first side of the structure.

4. The reference point locator of claim 1, wherein the receiver houses a battery for powering the sensor and the indicator.

5. The reference point locator of claim 1, wherein the receiver comprises a switch for selectively coupling the sensor and the indicator to a power source.

6. The reference point locator of claim 1, wherein the indicator is configured to emit a visual signal.

7. The reference point locator of claim 6, wherein the visual signal is produced by a light emitting diode (LED).

8. The reference point locator of claim 1, wherein the indicator is configured to emit an audible signal.

9. The reference point locator of claim 1, wherein the receiver comprises a hand-held receiver.

10. The reference point locator of claim 1, wherein the sensor is a reed switch.

11. The reference point locator of claim 10, wherein the receiver supports an accuracy-enhancing device for selectively biasing the reed switch toward a closed position.

12. The reference point locator of claim 11, wherein the accuracy-enhancing device is moveable between a retracted position and an extended position on the receiver.

13. The reference point locator of claim 12, wherein the accuracy-enhancing device is an annular magnet.

14. A reference point locator, comprising:
a sensor for detecting a magnetic field generated by a magnet;
an indicator configured to provide a user with feedback that the sensor has been brought within a first distance of the magnet; and
an accuracy-enhancing device configured to cause the indicator to provide feedback to the user in response to the sensor being brought within a second distance of the magnet, the second distance less than the first distance.

15. The reference point locator of claim 14, wherein the indicator is configured to emit a signal at the first distance and cease emitting the signal at the second distance.

16. The reference point locator of claim 14, wherein the accuracy-enhancing device is an annular magnet.

17. The reference point locator of claim 14, wherein the accuracy-enhancing device is an annular magnet slideably disposed on the receiver.

18. The reference point locator of claim 14, wherein the accuracy-enhancing device comprises an annular magnet for changing a state of the sensor.

19. The reference point locator of claim 14, wherein the accuracy-enhancing device is configured to change a state of the sensor based on a position of the accuracy-enhancing device relative to the sensor.

20. A method of manufacturing a reference point locator, comprising:
providing a reference member including an attachment element and a magnet, the attachment element configured to releasably secure the reference member to a first side of a structure; and
providing a receiver having a sensor and an indicator, the indicator configured to emit a signal in response to the sensor detecting from a second side of the structure a magnetic field generated by the magnet.

21. The method of claim 20, further comprising disposing an accuracy-enhancing device on the receiver.

22. The method of claim 20, further comprising locating a movable annular magnet on the receiver for changing a state of the sensor.
